(19) United States
(12) Patent Application Publication
(10) Pub. No.: US 2024/0253804 A1
(43) Pub. Date: Aug. 1, 2024

(54) ACOUSTICALLY-TREATED AIR EJECTION NOZZLE FOR A NACELLE

(71) Applicant: Safran Nacelles, Gonfreville L'Orcher (FR)

(72) Inventors: Vincent DUTOT, Moissy Cramayel (FR); Jean-Philippe Joret, Moissy Cramayel (FR); Marc Versaevel, Moissy Cramayel (FR); Vincent Lefeuvre, Moissy Cramayel (FR)

(73) Assignee: Safran Nacelles, Gonfreville L'Orcher (FR)

(21) Appl. No.: 18/627,959

(22) Filed: Apr. 5, 2024

Related U.S. Application Data
(63) Continuation of application No. PCT/FR2022/051868, filed on Oct. 3, 2022.

(30) Foreign Application Priority Data
Oct. 5, 2021 (FR) 2110533

(51) Int. Cl. F02K 1/34; B64D 29/00; F02K 1/82

(52) U.S. Cl. CPC B64D 33/06; B64D 29/00; F02K 1/827; F05D 2220/323; F05D 2260/963

(57) ABSTRACT

An air ejection nozzle for a nacelle includes an outer aerodynamic line and an inner aerodynamic line meeting at a trailing edge. The air ejection nozzle includes at discrete positions at least one area of larger thickness that is compensated by at least one fairing to connect the aerodynamic lines to form the trailing edge. The fairing includes an outer wall and an inner wall delimiting a cavity therebetween. The inner wall provides for the continuity of the inner aerodynamic line, and the outer wall is solid and the inner wall is pierced so that the at least one fairing forms an acoustic attenuation structure.

### CROSS-REFERENCE TO RELATED APPLICATIONS

This application is a continuation of International Application No. PCT/FR2022/051868, filed on Oct. 3, 2022, which claims priority to and the benefit of FR 21 10533 filed on Oct. 5, 2021. The disclosures of the above applications are incorporated herein by reference.

### FIELD

The present disclosure relates to an air ejection nozzle for a turbojet engine nacelle, and it also relates to a turbojet engine nacelle equipped with such a nozzle.

### BACKGROUND

The statements in this section merely provide background information related to the present disclosure and may not constitute prior art.

An aircraft is propelled by one or several propulsion unit(s) each including a bypass turbojet engine housed in a tubular nacelle. Each propulsion unit is attached to the aircraft by a mast generally located under a wing or at the level of the fuselage.

In general, such a nacelle has a structure including an air inlet upstream section upstream of the engine, a middle section intended to surround a fan of the turbojet engine, a downstream section able to accommodate thrust reversal elements and intended to surround the combustion chamber of the turbojet engine, and terminates in an air ejection nozzle of the nacelle.

The bypass turbojet engine housed in such a nacelle is able to generate a hot air flow (so-called primary flow) derived from the combustion chamber of the turbojet engine, and, via the blades of the rotating fan, a cold air flow (secondary flow) which circulates outside the turbojet engine through an annular channel, also so-called air duct, formed between an outer fairing and an inner fairing. The two air flows are ejected from the turbojet engine by the rear of the nacelle.

The outer fairing of the secondary flow is formed by a set of structural elements including, inter alia, from upstream to downstream in the direction of the air flow, the fairing of an air inlet, the fairing of a fan casing and the fairing of an ejection nozzle.

This set of elements is located in the vicinity of the turbojet engine and may generate in these structural elements a transmission of the acoustic noise originating from the turbojet engine outwards of the aircraft.

To limit the propagation of this acoustic noise, it is known to equip the inner fairing of the air inlet of the nacelle, the inner fairing of the fan or the fairing of an ejection nozzle with acoustic panels, that being so to attenuate the transmission of the noise generated by the turbojet engine.

Typically, the acoustic panels include a perforated acoustic skin and a core formed of a set of honeycomb cellular cells which is assembled over the acoustic skin. The perforated skin is turned towards the noise emission area, so that the acoustic waves may penetrate through the openings of the perforated skin inside the acoustic cells. The acoustic energy is dissipated by visco-thermal effect in the acoustic cells.

It is also desirable to provide for the attenuation of the acoustic noise in other structural elements forming the annular channel and proximate to the fan of the turbojet engine, like, for example, those forming the thrust reversal elements when a nacelle is equipped with such thrust reverser elements, to meet the increasingly strong regulatory standards and to meet the expectations of the residents of airport areas.

### SUMMARY

This section provides a general summary of the disclosure and is not a comprehensive disclosure of its full scope or all of its features.

The present disclosure provides an air ejection nozzle for a nacelle through which an air flow may pass. The air ejection nozzle includes an outer aerodynamic line and an inner aerodynamic line exposed to the air flow, the outer aerodynamic line and the inner aerodynamic line meeting at a trailing edge, the outer aerodynamic line and/or the inner aerodynamic line including at discrete positions at least one area of larger thickness compensated by a fairing ensuring connection of the inner and outer aerodynamic lines to form the trailing edge at these discrete positions, the fairing including an outer wall and an inner wall delimiting a cavity therebetween, and the inner wall ensures the continuity of the inner aerodynamic line.

According to the present disclosure, the outer wall is solid and the inner wall is pierced so that the fairing forms an acoustic attenuation structure.

Such a fairing is also so-called “beavertail” or “rear beam fairing” to designate its beavertail shape.

Such a fairing facilitates a flow of the air flow in the vicinity of the load-carrier structures of the turbojet engine, such as carrier beams of the turbojet engine.

In one form, a nacelle includes an inner fixed structure intended to receive an aircraft turbojet engine, an outer structure, defining with the inner structure a channel for the circulation of an air flow and, at discrete positions, a set of beams carrying the inner fixed structure. At these positions, inter alia, the beams cause an increase in the thickness of the trailing edge, which may reduce the aerodynamic performances of the nacelle. To overcome this, it is desirable to compensate, at these positions, this increase in the thickness of the trailing edge by the addition of such a fairing extending downstream to connect the outer and inner aerodynamic lines into the finest possible, and therefore an aerodynamically improved, trailing edge.

Thus, such a fairing is intended to provide the aerodynamic connection of the inner and outer aerodynamic lines into the finest possible trailing edge.

The present disclosure provides for using the structure of this fairing to form an acoustic attenuation structure using the outer wall which is solid and the inner wall which is pierced according to the present disclosure.

Thus, the present disclosure provides for structurally modifying this fairing, an acoustic function is advantageously added thereto, besides its aerodynamic function.

Moreover, the present disclosure is applicable to bypass turbojet engines with a large bypass ratio generating a cold air flow rate at least nine times as high as the hot air flow rate. In one variation the dilution ratio is between 9 and 11. In another variation the dilution ratio is between 15 and 20. Indeed, a nacelle associated with such a turbojet engine has a cold flow annular channel with a large size that accommodates such a flow rate. Hence, one of the direct consequences is an increase in the size of the nacelle and therefore an increase in the wetted surface of the annular channel. This results in a larger total diameter of the nacelle to be acoustically treated.

Thus, in the case of an application to a turbojet engine with a high bypass ratio, the consequence of increasing the diameter of the nacelle results in an increase in the size of this fairing. Thus, the wetted surface of this fairing proportionally to the wetted surface of the annular channel is large, about 1%. The acoustic treatment of this fairing then increases the efficiency of treatment of the acoustic attenuation of the nacelle as a whole.

One can distinguish the air ejection nozzle of the nacelle from an air ejection nozzle of the turbojet engine. In this regard, the air ejection nozzle of the nacelle channels a cold air flow, so-called the secondary air flow, while the air ejection nozzle of the turbojet engine channels a hot air flow, so-called the primary air flow.

According to other features of the present disclosure which may be considered alone or in combination with one another: the fairing may include stiffeners extending from the inner wall towards the outer wall, the stiffeners delimiting acoustic cells therebetween; the stiffeners may be distant from the outer wall by a predetermined distance, such as, in one variation, smaller than or equal to 3 mm; the cavity may include an insert core including a plurality of acoustic cells, such as, in one variation, alveolar; the fairing may be positioned at the level of an upper position of the nacelle, so-called “12 o'clock” position; the fairing may be positioned at the level of a lower position of the nacelle, so-called “6 o'clock” position; the fairing may be positioned at the level of a lateral position of the nacelle, so-called “3 o'clock” position; the fairing may be positioned at the level of a lateral position of the nacelle, so-called “9 o'clock” position; the nozzle may include two fairings as described before disposed on the air ejection nozzle opposite to one another.

The opposite arrangement of the two fairings extends with respect to a longitudinal main axis of the nacelle. As example, these two fairings may be disposed opposite to one another with respect to the longitudinal main axis of the nacelle at so-called “6 o'clock” and “12 o'clock” positions, or at so-called “3 o'clock” and “9 o'clock” positions.

According to another aspect, the present disclosure also relates to a nacelle including: an inner fixed structure intended to receive an aircraft turbojet engine, an outer structure, defining with the inner fixed structure, an annular channel for the circulation of an air flow, and a set of beams carrying the inner fixed structure, in which the outer structure includes an air ejection nozzle as defined before.

According to one form of the nacelle of the present disclosure, the fairing may be intended to at least partially surround a beam.

According to one form of the nacelle according to the present disclosure, the nacelle may include a thrust reverser having a movable cowl attached to the air ejection nozzle or forming the air ejection nozzle.

According to a variant of the nacelle according to the present disclosure, the nacelle may be devoid of thrust reversal elements.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents a schematic perspective view of a nacelle;

FIG. 2 represents a schematic cross-sectional view of a side view of the nacelle illustrated in FIG. 1;

FIG. 3 is a side view of a downstream section of the nacelle equipped with fairings allowing refining the trailing edge of a nozzle according to one form of the present disclosure;

FIG. 4 illustrates a perspective view of a front of a half-side of the downstream section of the nacelle according to one form of the present disclosure;

FIG. 5 illustrates a perspective view of a rear of a half-side of another downstream section of a nacelle according to one form of the present disclosure;

FIG. 6 illustrates a bottom view of an outer aerodynamic line of an air ejection nozzle equipped with a fairing provided in the “6 o'clock” position of the nacelle to connect the outer and inner aerodynamic lines to a trailing edge end at this position according to one form of the present disclosure;

FIG. 7 illustrates a perspective view of a fixed portion of the fairing of FIG. 6;

FIG. 8 illustrates a perspective view of a movable portion of the fairing of FIG. 6;

FIG. 9 illustrates a top view of the fixed portion of the acoustically-treated fairing represented in FIG. 8; and

FIG. 10 illustrates a schematic sectional view of a portion of the movable portion of the acoustically-treated fairing represented in FIG. 8.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The expressions “upstream” and “front” will be used indifferently to designate the upstream of the thrust reverser and the expressions “downstream” and “rear” will be used indifferently to designate the downstream of the thrust reverser.

The expressions “upstream” and “downstream” refer to the direction of the air flow entering and leaving a nacelle, in particular in the direct jet position when the nacelle is equipped with thrust reversal elements.

The expressions “inner” and “outer” should be understood as radial positions that are respectively internal or external relative to one another with respect to a longitudinal axis O of the nacelle.

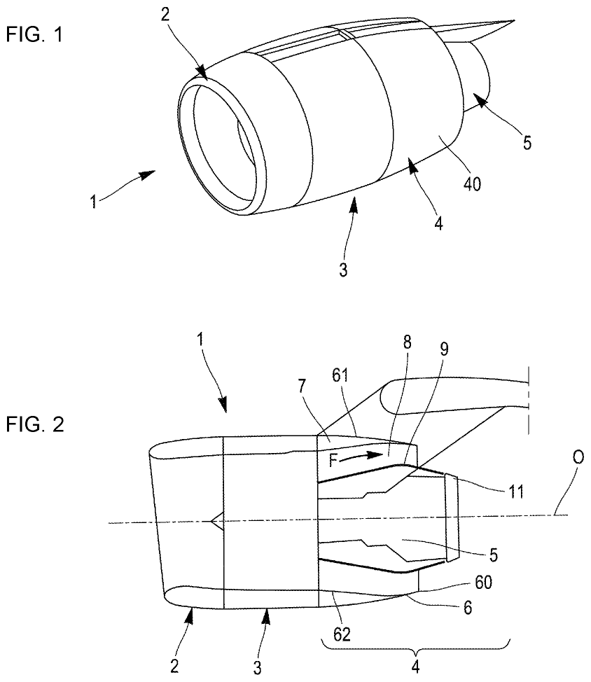

FIGS. 1 and 2 show a nacelle 1 of an aircraft extending according to a longitudinal axis O and comprising an air inlet upstream section 2, a middle section 3 intended to surround the fan (not visible), and a downstream section 4 intended to surround an engine compartment accommodating a turbojet engine 5 and which could include thrust reversal elements. The downstream section 4 also comprises an air ejection nozzle 6 of the nacelle 1 terminating the downstream section 4 in a trailing edge 60 of the nacelle 1.

The downstream section 4 of the nacelle 1 comprises an outer structure 7, comprising a fixed structure so-called OFS (Outer Fixed Structure) and a movable structure so-called Translating Cowl, which defines an annular flow channel 8 with a concentric inner structure 9, so-called IFS (Inner Fixed Structure), surrounding a downstream portion of the turbojet engine 5 behind the fan. A beam assembly (described later on) provides for the holding of the inner structure 9 relative to the outer structure 7.

The air ejection nozzle 6 of the nacelle 1 is delimited by an outer aerodynamic line 61 of the downstream section 4 and an inner aerodynamic line 62 of the downstream section 4 meeting at a trailing edge 60 of the nacelle 1.

The turbojet engine 5 includes an air ejection nozzle 11 of the turbojet engine 5, the outlet of which is located at the rear. The air drawn by the turbojet engine 5 forms, after combustion, a hot air flow ejected by the air ejection nozzle 11 of the turbojet engine 5.

For illustration, the outer structure 7 of the represented downstream section 4 may be equipped with thrust reversal elements, in this instance the downstream section 4 comprises a movable cowl 40 forming the outer aerodynamic line 61 of the nozzle 6. Of course, the present disclosure is not limited to such a nacelle 1, it could also include of a so-called smooth nacelle not equipped with, or devoid of, thrust reversal elements, that is to say where the upstream section 2, the middle section 3 and the downstream section 4 of the nacelle 1 are in aerodynamic continuity by being fastened to each other.

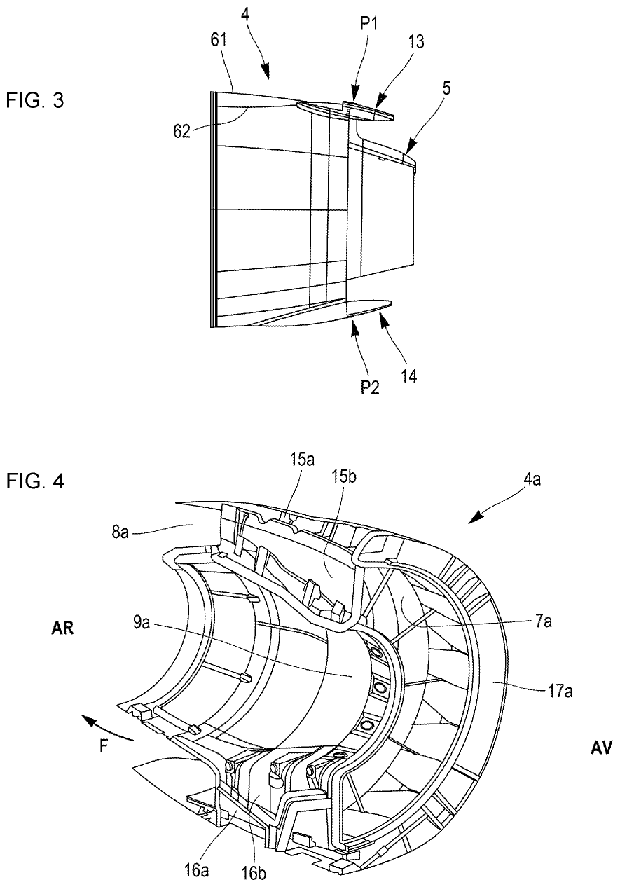

FIG. 3 shows the downstream section 4 of the nacelle 1 represented in FIGS. 1 and 2 equipped with two fairings 13, 14 allowing for refining the trailing edge 60 of the air ejection nozzle 6.

These two fairings 13, 14 are disposed at a downstream end of the downstream section 4, opposite to one another. More particularly, a first fairing 13 is disposed at an upper position, so-called “12 o'clock” position, and a second fairing 14 is positioned at a lower position, so-called “6 o'clock” position.

The first fairing 13 and the second fairing 14 are referred to as “beavertail” or “rear beam fairing” because of their beavertail shape used to connect the inner aerodynamic line 62 and the outer aerodynamic line 61 of the air ejection nozzle 6 of the nacelle 1.

As will be described hereinafter, such fairings 13, 14 allow accommodating the connection of the inner aerodynamic line 62 and outer aerodynamic line 61 of the nozzle 6 of the nacelle 1 through which the set of beams, described hereinbelow with reference to FIG. 4, pass. In one form the set of beam carry the inner structure 9.

FIG. 4 shows the downstream section 4 formed by a right half-shell 4a of the downstream section 4 which constitutes, together with a second half-shell (not represented), obtained by symmetry with respect to a midplane of the nacelle 1, the downstream section 4 of the nacelle 1 that is capable of surrounding the combustion chamber of the turbojet engine 5.

The references AV and AR respectively designate the front (upstream) and rear (downstream) portions of the half-shell 4a, with regards to the direction of the air flow intended to circulate inside this half-shell 4a.

In this instance, this half-shell 4a includes an inner half-structure 9a, defining a ventilation half-compartment intended to receive the turbojet engine 5. The inner structure 9 is obtained by assembly of two inner half-structures 9a (only the half-structure 9a is visible, the complementary half-structure being positioned symmetrically to the half-structure 9a with respect to the midplane of the nacelle 1).

This half-shell 4a also includes an outer half-structure 7a defining, with an inner half-structure 9a, an annular half-channel 8a through which a cold air flow F circulating between the front and the rear of the half-shell 4a is intended to pass and defining, with the complementary annular half-channel obtained by symmetry with respect to the midplane of the nacelle 1, the annular channel 8 or air flow path.

The connection of the turbojet engine 5 to the aircraft is achieved via a support structure comprising two upper longitudinal half-beams 15a (only the half-beam 15a is visible in FIG. 4, the complementary half-beam being positioned symmetrically to the half-beam 15a with respect to the midplane of the nacelle 1), called “12 o'clock” beams because of their position at the top of the nacelle 1; and two lower longitudinal half-beams 16a (only the half-beam 16a is visible in FIG. 4, the complementary half-beam being positioned symmetrically to the half-beam 16a with respect to the midplane of the nacelle 1), called “6 o'clock” beams because of their position in the lower part of the nacelle 1.

Half-bifurcations 15b, 16b connected to the half-beams 15a, 16a are intended to pass through the annular channel 8 in order to provide mechanical strength to the inner half-structure 9a.

The “12 o'clock” or upper half-beam 15a and the “6 o'clock” or lower half-beam 16a are ducted via fairing sheet metals, in this instance by the first fairing 13 and the second fairing 14, represented in FIG. 3, and are intended to come into contact with the air flow F passing through the annular channel 8 of the nacelle 1.

The “12 o'clock” and “6 o'clock” or upper and lower half-beams 15a, 16a are connected to one another, on the one hand, via the half-bifurcations 15b, 16b passing through the annular channel 8 and connected to the inner structure 9 surrounding the turbojet engine 5 and, on the other hand, by an annular structure the front frame that is generally formed by two front half-frames 17a (only the front half-frame 17a is visible in FIG. 4, the complementary front half-frame being positioned symmetrically to the front half-frame 17a with respect to the midplane of the nacelle 1) each extending between the corresponding half-beams 15a, 16a on either side of the midplane of the nacelle 1. This front half-frame 17a is intended to be fastened to the periphery of a downstream edge 4 of a casing of the fan of the turbojet engine 5 and thus contribute to the recovery and transmission of the forces between the different portions of the nacelle 1 and of the turbojet engine 5. Furthermore, in the case of a nacelle 1 equipped with a cascade thrust reverser device, the front half-frame 17a may also serve to support the cascades of the thrust reverser.

Generally, a cascade thrust reverser comprises two half-cowls (forming the movable cowl 40 visible in FIG. 1) each slidably mounted on the upper half-beam 15a and the lower half-beam 16a. To this end, the upper half-beam 15a and the lower half-beam 16a are generally equipped with primary and secondary guide rails facilitating a sliding movement of the half-cowls of the cascade thrust reverser, over the associated half-beam 15a, 16a alternately between a direct jet position of the thrust reverser according to which the half-cowls provide the aerodynamic continuity of the nacelle 1 and a reverse jet position of the thrust reverser according to which the half-cowls are displaced downstream of the nacelle 1.

Thus, the set of upper half-beams 15a and lower half-beams 16a extend, at discrete positions P1, P2 (herein located at “12 o'clock” and “6 o'clock”), from the outer structure 7 of the nacelle 1 at least through the inner aerodynamic line 62 of the nozzle 6 (represented in FIGS. 2 and 3). At these discrete positions P1, P2, the outer aerodynamic line 61 and/or the inner aerodynamic line 62 of the nozzle 6 has an area of larger thickness imposed, inter alia, by these half-beams 15a, 16a. By the expression “area of larger thickness”, it should be understood that the distance between the outer aerodynamic line 61 and the inner aerodynamic line 62 is generally smaller than their distance from one another in the area. In other words, it should be understood that the outer aerodynamic line 61 and/or the inner aerodynamic line 62 of the nozzle 6 has over its generally cylindrical circumference an area projecting towards a main axis of revolution of the nozzle 6. In one example, the main axis of revolution of the nozzle 6 may be common to the longitudinal axis O of the nacelle 1. This large aerodynamic thickness is compensated by the first fairing 13 and the second fairing 14 to connect, at these discrete positions P1, P2, the outer aerodynamic line 61 and inner aerodynamic line 62 into a fine trailing edge 60.

Thus, it should be understood that at the discrete positions P1 and P2, the first fairing 13 and the second fairing 14 extend downstream beyond the trailing edge 60 formed by the connection of the outer aerodynamic line 61 and the inner aerodynamic line 62 outside these discrete positions P1, P2.

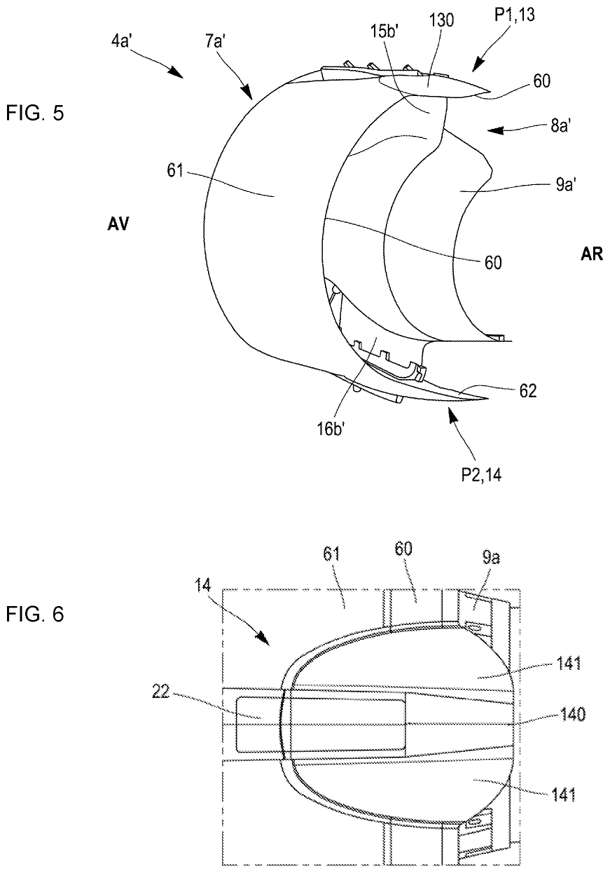

FIG. 5 shows another representation of the downstream section 4 also formed by a half-shell 4a′ of the downstream section 4 which constitutes, together with a second half-shell (not represented), obtained by symmetry with respect to a midplane of the nacelle 1), the downstream section 4 of the nacelle 1 capable of surrounding the combustion chamber of the turbojet engine 5.

In the same way, the references AV and AR respectively designate the front (upstream) and rear (downstream) portions of the half-shell 4a′ with respect to the direction of the air flow intended to circulate inside this half-shell 4a′.

The half-shell 4a′ includes an outer half-structure 7a′ defining, together with an inner half-structure 9a′ and an annular half-channel 8a′, a passage through which a cold air flow F circulating between the front and the rear of the half-shell 4a′ is intended to pass.

Half-bifurcations 15b′, 16b′ connected to the half-beams 15a′, 16a′ are provided to pass through the annular half-channel 8a′ in order to provide mechanical strength to the inner half-structure 9a′.

The first fairing 13 and the second fairing 14 are also represented, which extend downstream beyond the trailing edge 60 formed by connection of the outer aerodynamic line 61 and the inner aerodynamic line 62 outside these discrete positions P1, P2. At these discrete positions P1, P2, this first fairing 13 and the second fairing 14 provide connection of the outer aerodynamic line 61 and inner aerodynamic line 62 into the finest possible trailing edge 60.

It should be understood that the reference numeral 60 also defines the trailing edge 60 of the downstream section 4a′ outside these discrete positions P1, P2 and at these discrete positions P1, P2.

As represented, the first fairing 13 allows enclosing an area 130 forming an embossing on the outer aerodynamic line 61 intended for the integration of connection elements of the nacelle 1. In order to provide an improved aerodynamic function at this “12 o'clock” discrete position P1, the first fairing 13 extends downstream beyond the trailing edge 60 outside these positions, that being so to form the thinnest possible trailing edge 60 at this discrete position P1.

FIG. 6 shows the second fairing 14, at the “6 o'clock” position, which extends beyond the trailing edge 60 connecting the outer aerodynamic line 61 and inner aerodynamic line 62 outside the discrete positions P1, P2.

In the case where the nacelle 1 comprises a thrust reverser equipped with a movable cowl 40, this second fairing 14 may be at least partially movable relative to the outer structure 7.

Thus, in the represented example, the second fairing 14 comprises a fixed portion 140 and a movable portion 141.

The fixed portion 140 of the second fairing 14 is connected to a structural element of the nacelle 1, such as a beam herein represented by a beam fairing 22.

The movable portion 141 is secured to the outer structure 7 belonging to the downstream section 4 and therefore secured to the movable cowl 40.

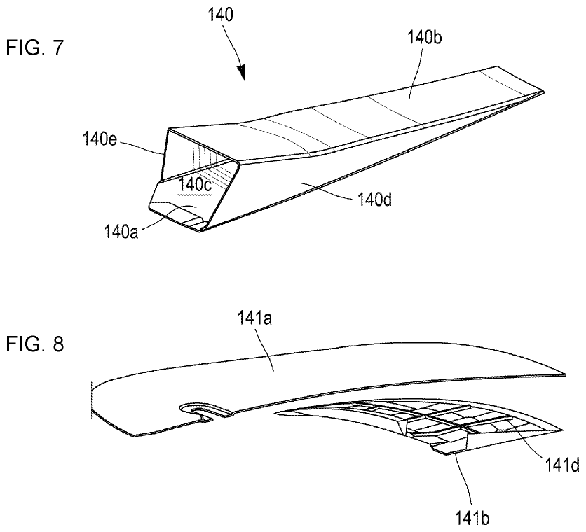

The fixed portion 140 may be formed by a fairing of frustoconical rectangular shape as represented in FIG. 7.

The fairing with a frustoconical rectangular shape forming the fixed portion 140 of the second fairing 14 includes an outer wall 140a and an inner wall 140b opposite to one another, respectively intended to form at least the outer aerodynamic line 61 and the inner aerodynamic line 62 of the nozzle 6. The outer wall 140a and the inner wall 140b of the fixed portion 140 of the second fairing 14 delimit therebetween a cavity 140c laterally closed by two lateral walls 140d, 140e.

The outer wall 140a and the lateral walls 140d, 140e forming the cavity 140c are solid, and are generally not intended for the penetration of an air flow into the cavity 140c.

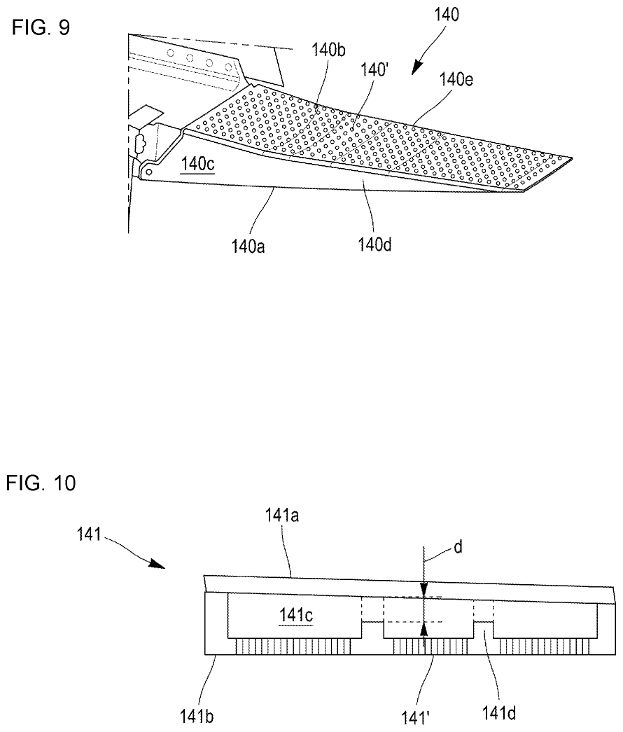

As illustrated in FIG. 9, the present disclosure provides for piercing the inner wall 140b of the fixed portion 140 of the second fairing 14 with a plurality of apertures 140′ such that the fixed portion of the second fairing 14 forms an acoustic attenuation structure where the cavity 140c has an acoustic function.

Advantageously, the open surface formed by the plurality of apertures 140′ may represent 5% to 12% of the surface of the inner wall 140b of the fixed portion 140 of the second fairing 14. Such a percentage is designated by the English acronym POA standing for “Percentage of Open Area”.

Due to the configuration of this fixed portion 140 of the fairing 14, it is possible to acoustically treat an additional area forming the annular channel 8 exposed to the air flow, without requiring the use of an acoustic core in the cavity 140c of the fixed portion 140 of the second fairing 14. Thus, the air ejection nozzle 6 of the nacelle 1 is improved for acoustic attenuation in the portion of the trailing edge 60 exposed to the air flow F passing through the nacelle 1.

The inner wall 140b pierced with the fixed portion 140 of the second fairing 14 forms a perforated skin facing the noise emission area, so that the acoustic waves may penetrate through the apertures 140′ of the perforated skin inside the resonant cavity 140c. The acoustic energy is dissipated by visco-thermal effect in the resonant cavity 140c. The resonant cavity 140c forms a Helmholtz resonator.

In one example, the apertures 140′ of the pierced inner wall 140b may have a diameter comprised between 1 mm and 3 mm.

According to a variant, the second fairing 14 may comprise an acoustic core in the cavity 140c, such as a honeycomb cellular core. The core is then joined to the pierced inner wall 140b from which it extends. Advantageously, this acoustic core is distant from the outer wall 140a by a predetermined distance smaller than or equal to 3 mm. In one variation, the cavity 140c includes an insert core including a plurality of acoustic cells. In one form the insert core may be the acoustic core. In one aspect, the acoustic cells are alveolar.

As represented in FIG. 6, the fixed portion 140 separates two sub-fairings (also referenced 141) from the movable portion 141 of the second fairing 14.

FIG. 8 shows one single sub-fairing of the movable portion 141 of the second fairing 14 formed by assembly of an inner wall 141b exposed to the air flow F passing through the annular channel 8 of the nacelle 1 and an outer wall 141a. The outer wall 141a and the inner wall 141b are respectively intended to form at least the outer aerodynamic line 61 and the inner aerodynamic line 62 of the nozzle 6.

The inner wall 141b is mechanically held by a plurality of stiffeners 141d extending from the inner wall 141b. In the assembled state, the inner wall 141b and the outer wall 141a are opposite to one another and delimit a cavity 141c (represented in FIG. 9).

The outer wall 141a forming the cavity 141c is solid, and is generally not intended for the penetration of an air flow into the cavity 141c.

As represented in FIG. 10, it is provided to pierce a plurality of apertures 141′ in the inner wall 141b (partially represented) of the movable portion 141 of the second fairing 14, which is exposed to the air flow F passing through the annular channel 8 of the nacelle 1, to form an acoustic attenuation structure.

In one example, the open surface formed by the plurality of apertures 141′ may represent 5% to 12% of the surface area of the inner wall 141b of the movable portion 141 of the second fairing 14.

The pierced inner wall 141b of the movable portion 141 of the second fairing 14 forms a perforated skin facing the noise emission area, so that the acoustic waves can penetrate through the apertures 141′ of the perforated skin inside the resonant cavity 141c. The acoustic energy is dissipated by visco-thermal effect in the resonant cavity 141c.

In one example, the height of the stiffeners 141d may be increased so that they are distant from the outer wall 141a by a distance d smaller than or equal to 3 mm.

Thus, this height of the stiffeners 141d has the effect of partitioning the cavity 141c by formation of the acoustic cells.

Moreover, a distance smaller than or equal to 3 mm allows acoustically closing each acoustic cell thus formed.

The distance may be zero, nonetheless, in one example, this distance is non-zero in order to form a clearance allowing avoiding any setting constraint to the assembly while ensuring acoustic closure of the acoustic cells. Thus, it should be understood that the stiffeners 141d in this example form acoustic cells.

The first fairing 13 in “12 o'clock” position is entirely movable. Thus, it may advantageously be formed by assembly of two walls, as described with reference to the sub-fairing of the movable portion 141 of the second fairing 14.

In one example, its open surface formed by a plurality of apertures may represent 5% to 12% of the surface area of the inner wall of the movable portion 141.

Although the present disclosure has been illustrated applied to an “underwing-mounted engine” configuration, it is applicable to a “fuselage side-mounted engine” configuration.

Of course, the present disclosure is not limited to the examples that have just been described and numerous arrangements could be made to these examples without departing from the scope of the present disclosure. In this regard, the different features, shapes, variants and forms of the present disclosure may be associated with one another according to various combinations to the extent that they are not incompatible or exclusive of one another. In this regard, all of the previously-described variants and forms can be combined with one another.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An air ejection nozzle for a nacelle configured to receive an air flow, the air ejection nozzle comprising:
an outer aerodynamic line;
an inner aerodynamic line configured to be exposed to the air flow, the outer aerodynamic line and the inner aerodynamic line meeting at a trailing edge, at least one of the outer aerodynamic line and the inner aerodynamic line including at discrete positions at least one area with a thickness that is compensated by at least one fairing that is configured to connect the inner aerodynamic line and the outer aerodynamic line to form the trailing edge at the discrete positions; and
the at least one fairing including an outer wall and an inner wall delimiting a cavity therebetween, the inner wall configured to provide continuity of the inner aerodynamic line, the outer wall is solid and the inner wall is pierced so that the at least one fairing forms an acoustic attenuation structure.

2. The air ejection nozzle according to claim 1, wherein the at least one fairing includes at least one stiffener extending from the inner wall towards the outer wall, the at least one stiffener delimiting acoustic cells therebetween.

3. The air ejection nozzle according to claim 2, wherein the at least one stiffener is distant from the outer wall by a predetermined distance.

4. The air ejection nozzle according to claim 3, wherein the at least one stiffener comprises a plurality of stiffeners, each distant from the outer wall by the predetermined distance, and the predetermined distance is smaller than or equal to 3 mm.

5. The air ejection nozzle according to claim 1, wherein the cavity includes an insert core including a plurality of acoustic cells.

6. The air ejection nozzle according to claim 5, wherein the plurality of acoustic cells are alveolar.

7. The air ejection nozzle according to claim 1, wherein the at least one fairing comprises two fairings disposed on the air ejection nozzle opposite to one another.

8. An aircraft nacelle comprising:
an inner fixed structure configured to receive an aircraft turbojet engine;
a set of beams carrying the inner fixed structure;
an outer structure defining with the inner fixed structure an annular channel for circulation of an air flow, and the outer structure comprises an air ejection nozzle including:
an outer aerodynamic line;
an inner aerodynamic line configured to be exposed to the air flow, the outer aerodynamic line and the inner aerodynamic line meeting at a trailing edge, at least one of the outer aerodynamic line and the inner aerodynamic line including at discrete positions at least one area with a thickness that is compensated by at least one fairing that is configured to connect the inner aerodynamic line and the outer aerodynamic line to form the trailing edge at the discrete positions; and
the at least one fairing includes an outer wall and an inner wall delimiting a cavity therebetween, the inner wall configured to provide continuity of the inner aerodynamic line, the outer wall is solid and the inner wall is pierced so that the at least one fairing forms an acoustic attenuation structure.

9. The aircraft nacelle according to claim 8, wherein the at least one fairing of the air ejection nozzle is configured to at least partially surround a beam of the set of beams.

10. The aircraft nacelle according to claim 8, further comprising a thrust reverser including a movable cowl fastened to the air ejection nozzle.

11. The aircraft nacelle according to claim 8, further comprising a thrust reverser including a movable cowl forming the air ejection nozzle.

12. The aircraft nacelle according to claim 8, wherein the aircraft nacelle is devoid of a thrust reverser.
